(19) United States
(12) Patent Application Publication
(10) Pub. No.: US 2007/0252392 A1
(43) Pub. Date: Nov. 1, 2007

(54) ACCESS COVER

(75) Inventor: John Newton, Cumbria (GB)

Correspondence Address: DARBY & DARBY P.C., P.O. BOX 770, Church Street Station, New York, NY, 10008-0770, US

(73) Assignee: Structural Science Composites Ltd., Cumbria (GB)

(21) Appl. No.: 11/463,213

(22) Filed: Aug. 8, 2006

(30) Foreign Application Priority Data
Apr. 13, 2006 (GB) 0607527.9

(51) Int. Cl. E05C 9/12

(52) U.S. Cl. 292/39

(57) ABSTRACT

An access cover comprising a generally non-metallic body, the body being adapted to be received in a frame to provide a closure for an access chamber; at least one locking mechanism adapted to releasably secure the body to the frame; the locking mechanism being adapted to be actuated by a tool; the locking mechanism comprising: a bolt moveable between an extended position wherein the bolt may be engaged within a recess of the frame; a retracted position wherein the bolt may be withdrawn from a recess to permit removal of the cover from the frame; and a socket adapted to receive the tool to actuate the locking mechanism and to permit lifting of the cover using the tool.

This invention relates to a cover for an access chamber such as a manhole, inspection chamber or other enclosure which may be provided in the surface of a thoroughfare such as a road, walkway, runway, driveway or forecourt, to permit access by a person or equipment into an underlying chamber.

Conventional covers for access chambers comprise cast iron or steel plates. These must have sufficient strength to support the weight of persons or vehicles in normal use of the thoroughfare. Metallic covers have several disadvantages. They are electrically conductive so that there is a risk of electrocution of a person or animal standing on the cover in the event of a fault with electrical equipment in the underlying chamber. This is a particular risk in metropolitan developments in which very high voltage supplies are used where salt is applied during winter, increasing the likelihood of corrosion of electrical equipment. There is also a problem of thermal conductivity particularly in relation to steam generation or supply equipment.

Cast iron or steel covers are heavy and present a lifting hazard to workers who are required to raise them to gain access to the underlying chambers. Furthermore such covers form dangerous projectiles in the event of a gas explosion in the underlying chamber.

Access chambers composed of non-metallic compositions have been disclosed in our co-pending Irish patent application no. S2005/0552. However these are lighter and more easily lifted resulting in a risk of theft or vandalism.

According to a first aspect of the present invention an access cover comprises a generally non-metallic body, the body being adapted to be received in a frame to provide a closure for an access chamber;

at least one locking mechanism adapted to releasably secure the body to the frame;

the locking mechanism being adapted to be actuated by a tool;

the locking mechanism comprising:

a bolt moveable between an extended position wherein the bolt may be engaged within a recess of the frame;

a retracted position wherein the bolt may be withdrawn from a recess to permit removal of the cover from the frame; and

a socket adapted to receive the tool to actuate the locking mechanism and to permit lifting of the cover using the tool.

A cover in accordance with this invention confers several advantages. The tool may be used to unlock the cover from the frame and to lift the cover in a single operation. In a preferred embodiment two locking mechanisms in accordance with this invention are provided at opposite sides of the cover so that the cover may be conveniently unlocked and lifted from the frame using two tools. In this way misalignment of the cover within the frame and possible jamming are avoided.

The locking mechanism and housing may be embedded in the body of composite material from which the cover is constructed. This provides the further advantage that the external upwardly facing surface of the locking mechanism may be electrically insulated from the frame, reducing the risk of electrical shocks to persons or animals standing on the cover, in the event that the frame becomes inadvertently connected to an electrical supply.

The housing for the locking mechanism may be formed in two parts in order to facilitate manufacture. An upper part of the housing is then placed upside down into a mould and a glass fibre laminate placed over the housing. The lower part of the housing is then placed on the upper part of the housing and the two are bolted together or otherwise secured to bind the glass fibre laminate between the two housing portions. The remainder of the laminates are then added to complete formation of the cover and the laminates are infused with a matrix resin to form the composite.

In a particularly preferred embodiment the locking mechanism is arranged so that the tool is securely engaged within the locking mechanism when the bolt is retracted, preventing the cover from being separated from the tool. The risk of dropping the cover during lifting is thereby reduced.

The tool may include a head adapted to be inserted into the socket. The head may be rotated to actuate the locking mechanism.

In a preferred embodiment the head includes at least one, preferably two, radially extending protuberances, the socket having a complimentary shaped mouth to permit insertion and engagement with the tool in the first orientation but preventing removal of the tool after rotation of the tool within the socket.

The tool and socket may therefore cooperate to form a key and key hole arrangement wherein the tool may be inserted only in or two particular orientation.

According to the second aspect of the invention an access cover assembly comprises a cover in accordance with the first aspect of this invention together with a tool.

The head of the tool may comprise a cylindrical body with two diametrically opposed radially extending protuberances, the socket having a cover plate with an aperture defining a mouth to receive the head with the protuberances aligned in the bolt extended position. The downwardly facing inner surface of the cover plate preferably has one or more rebates or abutments dimensioned to receive the protuberance or protuberances when the tool is rotated to the bolt retracted position. In this position lifting of the tool engages the one or more protuberances with the rebates or abutments, securely engaging the tool and preventing movement relative to the cover as it is raised.

The bolt may include a toothed rack adapted to engage a pinion on the socket so that rotation of the socket extends or retracts the bolt. The rack may be laterally offset from the axis of the bolt so that the axis of rotation of the socket and tool are aligned with and intersect perpendicularly with the longitudinal axis of the bolt.

In a preferred embodiment a security plug is adapted to seal the housing from ingress of water, dirt and other contaminants. The plug serves to exclude water, preventing ice forming in the mechanism during use. The plug is preferably arranged to be flush with and form a continuous surface with the upper surface of the cover. The plug may be screw threaded and adapted to be removed using an actuator integral with the tool and having a unique configuration. In this way removal of the cover using a screwdriver or other commonly available tool is prevented.

A deadlocking member may extend downwardly from the security plug. The deadlocking member may be a bar or rod similarly dimensioned to the protuberances of the tool to be received in the socket to prevent rotation of the pinion relative to the housing of the locking assembly. In this way the bolt cannot be forced into the housing from the extended to the retracted position by external pressure or due to vibration in use.

A spring may be provided to urge the pinion upwardly into contact with the housing of the lock mechanism, preventing ingress of dirt or contaminants.

According to a third aspect of the present invention a lifting tool for an access chamber comprises:

a shaft;

a handle at a proximal end of the shaft; and

a head at a distal end of the shaft;

the head being adapted to operatively engage a socket in the cover in accordance with the first aspect of the invention.

The head may comprise a generally cylindrical member having at least one protuberance extending radially from the member.

A hinge or pivot may be provided in the shaft at a location spaced from the head to allow the shaft and handle to be pivoted relative to the access of the head. The hinge or pivot may extend laterally at the handle to provide a lifting point for leverage to be applied to loosen the cover if it becomes stuck in the frame in use.

The invention is further described by means of example but not in any limitative sense with reference to the accompanying drawings of which:

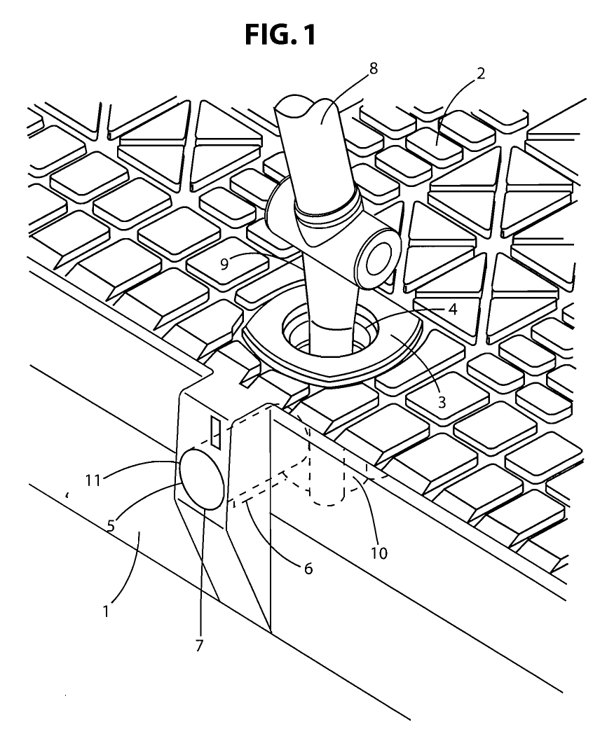

FIG. 1 is a perspective view of a locking arrangement in accordance with the present invention;

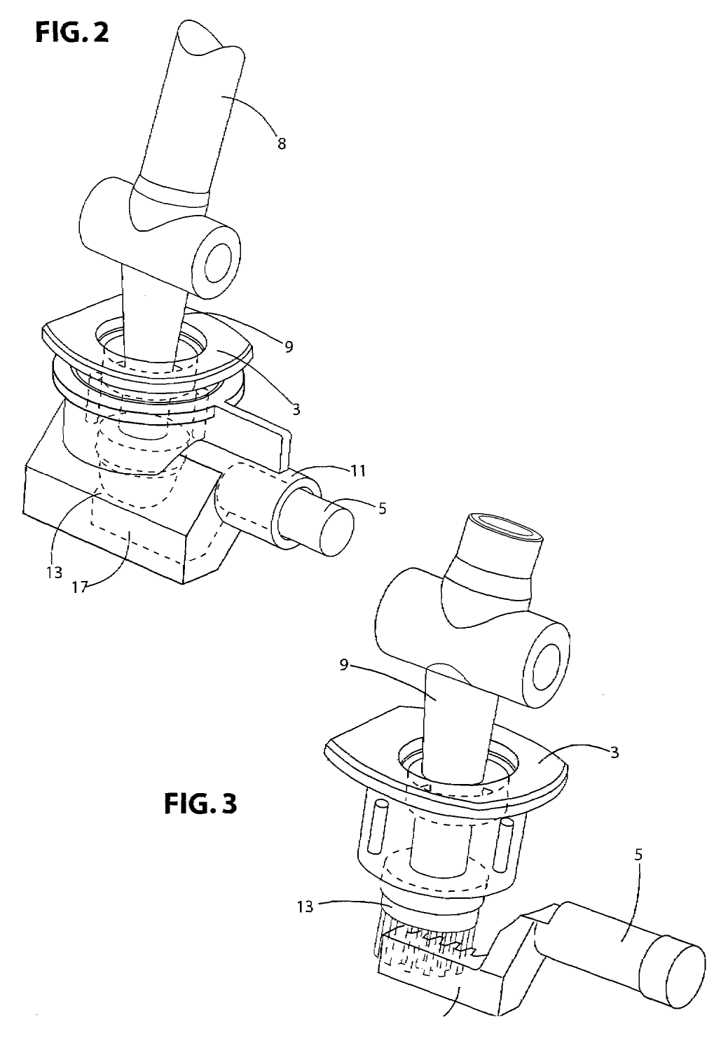

FIGS. 2 to 4 illustrate components of the locking arrangement and tool;

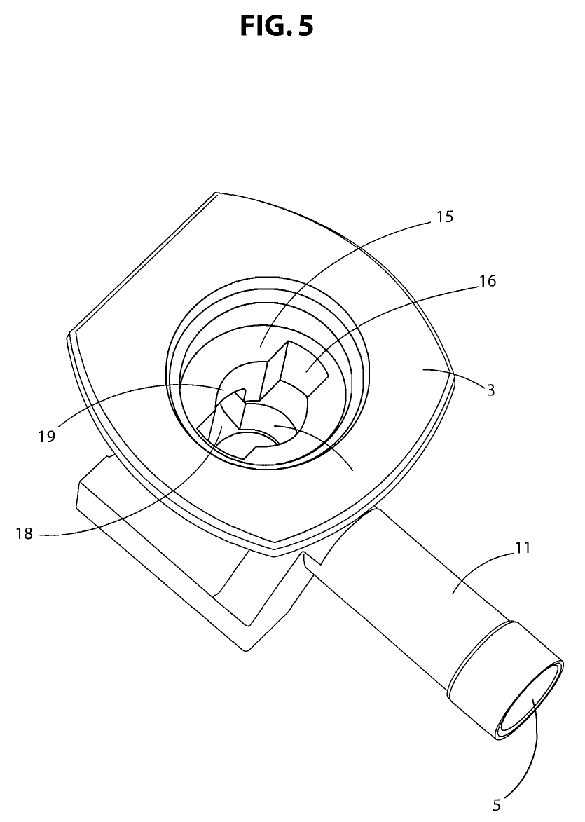

FIG. 5 illustrates the socket of the arrangement;

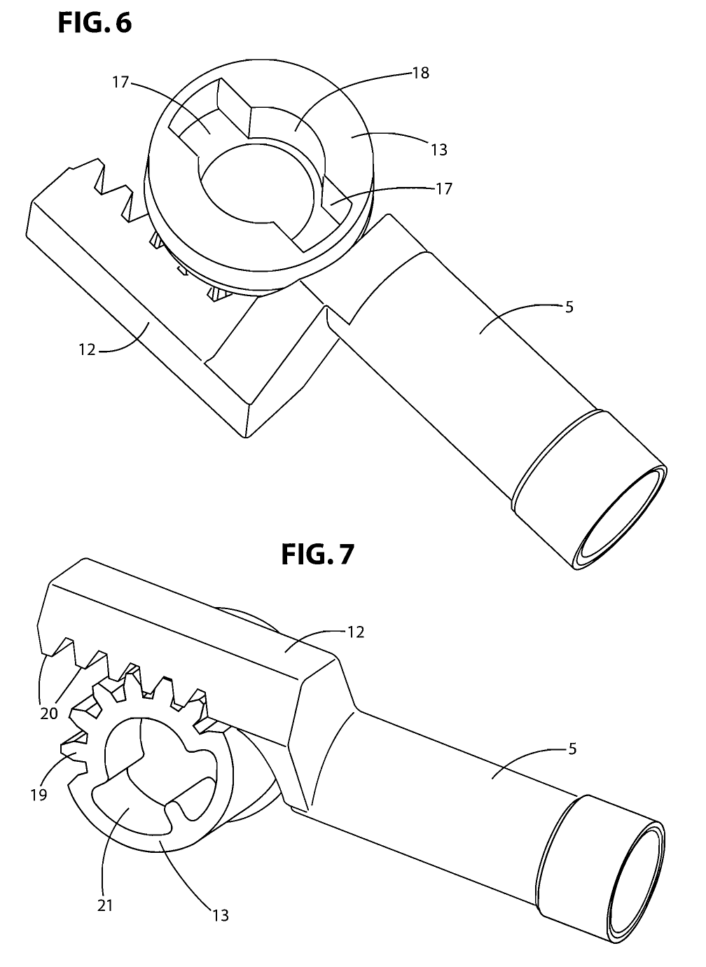

FIGS. 6 and 7 illustrates the bolt and pinion;

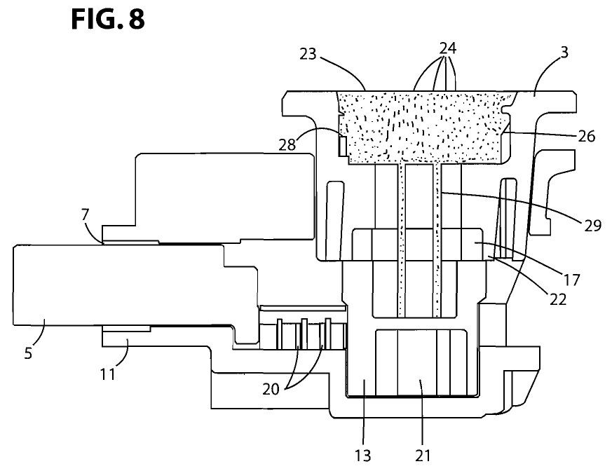

FIG. 8 is a cross-sectional view of the locking arrangement;

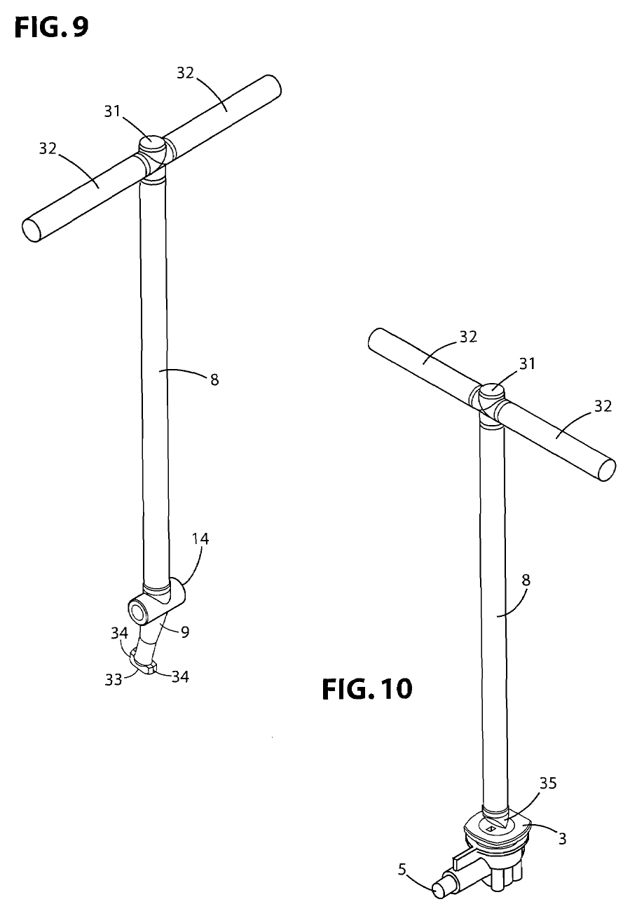

FIG. 9 illustrates the tool;

FIG. 10 illustrates the tool inserted into the security plug;

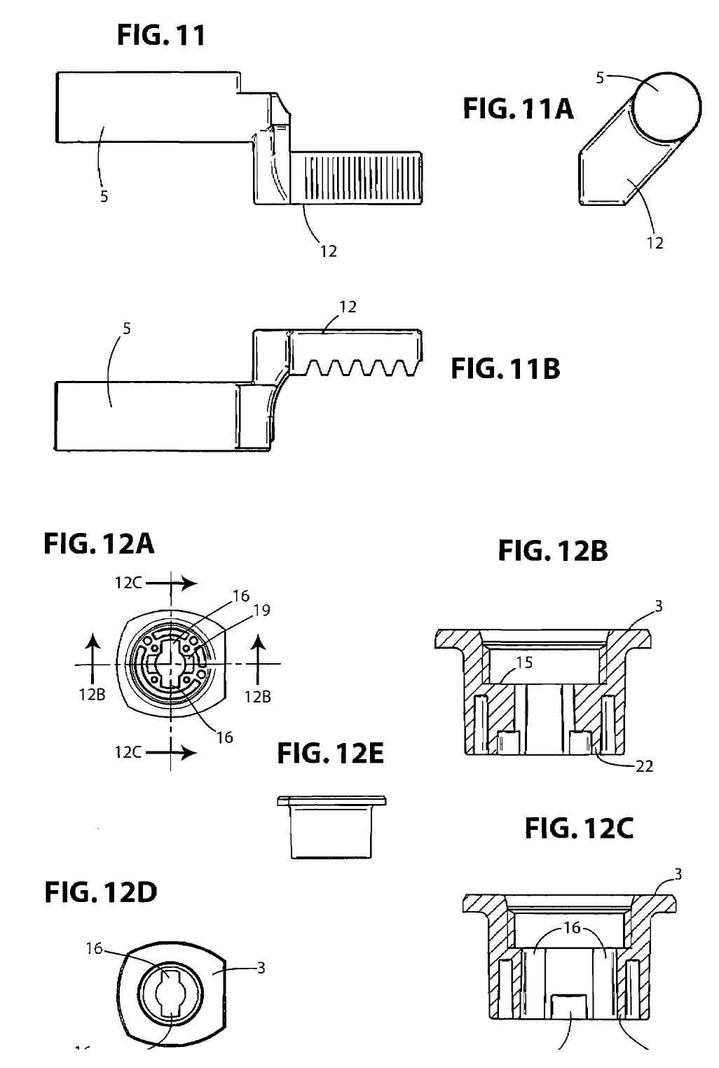

FIG. 11 comprises a plan and side and end elevations of the bolt;

FIG. 12 shows the housing of the locking arrangement;

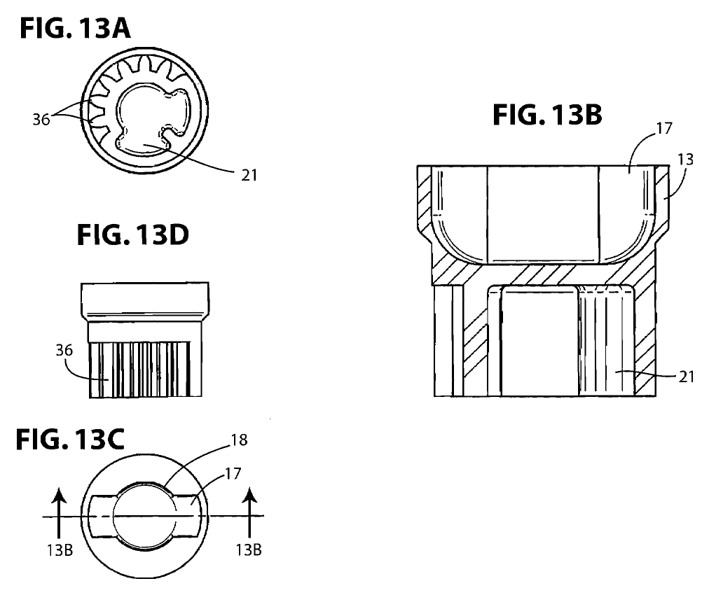

FIG. 13 shows the socket and pinion;

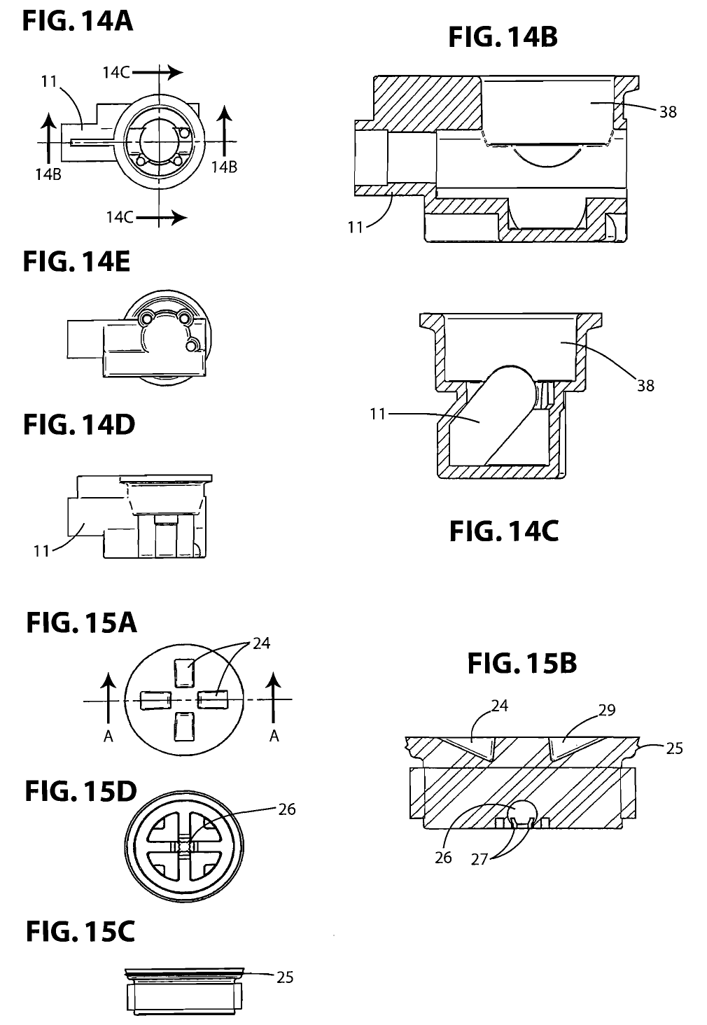

FIG. 14 shows the lower housing of the locking arrangement;

FIG. 15 shows the security plug;

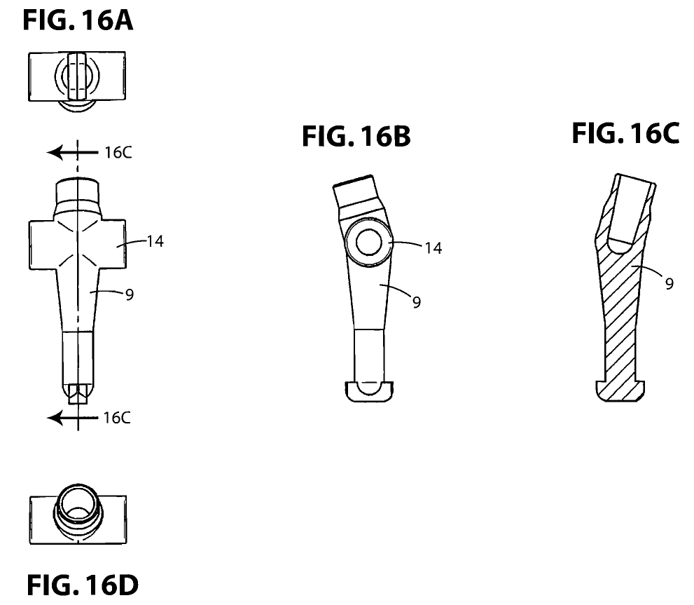

FIG. 16 shows the head of the tool; and

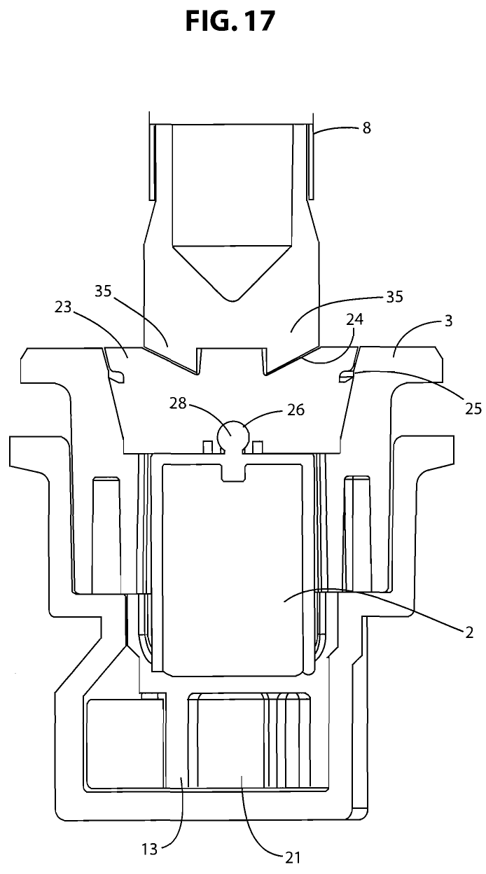

FIG. 17 shows a cross-sectional view of the locking arrangement showing removal of the security plug.

FIG. 1 is a perspective view illustrating a locking arrangement of an access chamber cover in accordance with the present invention. The cover (1) composed of composite polymeric material has a non-slip upper surface (2) in conventional manner. The locking arrangement comprises an upper surface (3) defining a socket (4). A bolt (5) is supported by a bearing sleeve (7) in a guideway (11) extending from a housing (6). The housing (6) forms a rib for reception into a complimentary shaped recess in the supporting frame (not shown) for the access cover. The actuation tool has a head (not shown) supported by a tapering portion (9). The head is inserted into a socket in the locking mechanism housing (10) described in greater detail below.

In use of the locking arrangement the tool (8, 9) is inserted into the opening (4) in the locking mechanism (3). Rotation of the shaft (8) causes the bolt (5) to be driven outwardly from the sleeve (11) securing the cover within the surrounding frame (not shown). The tool is then removed and a dirt excluding security plug and deadlocking bar (not shown) are inserted into the opening (4) to close and seal it.

FIG. 2 is a schematic view illustrating the moving components. The bolt (5) is extended from the sleeve (11). The bolt (5) carries a toothed rack (12) which engages a pinion (13). The rack (12) is laterally offset from the centre line of the bolt (5), sleeve (11) and the access of the tool (8, 9) and locking device. Rotation of the shaft (8) causes the pinion (13) to rotate in parting linear movement to the bolt (5).

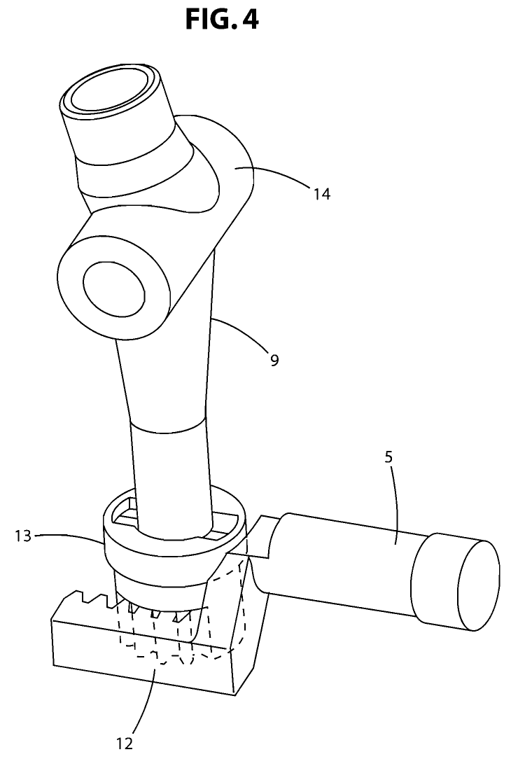

FIG. 3 is a further perspective view illustrating the arrangement shown in FIG. 2. In FIG. 3 the bolt (5) is extended, the tool (9) having been rotated through 90°. In FIG. 4 the bolt (5) is retracted the tool being rotated so that the cross member (14) is disposed transversely of the access of the bolt (5). In this position a lifting device (not shown) located on the ground beside the cover can be used to lift the tool (9) to release the cover if it is stuck within the frame, for example due to an accumulation of debris.

FIG. 5 illustrates the upper housing or bolt or the socket for reception of the tool. The upper cover (15) has an axial cylindrical bore and two diametrically opposed radially extending recesses (16) adapted to receive the protuberances of the head of the tool. The tool must be correctly aligned so that the head is inserted in the manner of a key into a lock. As shown in FIG. 5 the pinion (13) has been rotated through 90° so that the lower part (17) of the recess is aligned with a rebate (19) in a downwardly facing surface of the plate (15). When the tool (not shown) is raised protuberances engage the rebate (19) securely holding the access cover enabling it to be lifted safely.

FIG. 6 shows the bolt (5) and rack (12) engaging the pinion (13). The socket (18) and two diametrically opposed recesses (17) receive the head of the tool (not shown). Rotation of the head of the tool extends or retracts the bolt (5) locking or unlocking the cover from the surrounding frame.

FIG. 7 illustrates the bolt and pinion arrangement from below, The teeth extend half of the circumference of the pinion and engage the corresponding teeth (20) of the rack (12). A rebate (21) serves to receive a spring (not shown). The spring urges the pinion upwardly into contact with the upper portion of the housing (22) as shown in FIG. 8. This prevents seepage of dirt or contaminants downwardly into the rack and pinion arrangement.

FIG. 8 is a cross-sectional view of the locking arrangement. The security plug (23) has four wedge-shaped notations (24) on the upper surface adapted to receive a tool for insertion or removal of the security plug. The wedge-shaped portions are configured so that a tool driven vertically downwardly into the cap displaces any dirt or contaminants contained in the recesses (24). The construction of the security plug is shown in greater detail in FIG. 15. A sealing ring (25) serves to ensure a tight seal with the housing.

A socket (26) including a spring clip (27) located on the lower surface of the security plug is to receive a ball head (28), a locking member (29) as shown in FIG. 8. The locking member is generally rectangular in section and extends downwardly into the socket being received in the rebates (16) and (17) to provide a deadlocking arrangement. When inserted, the locking member (29) prevents rotation of the pinion so that the bolt (5) is locked in the extended position).

FIG. 9 illustrates the tool in accordance with the invention. The shaft (8) carries a cross-member (31) and handles (32). The handles may be detachable to allow convenient storage and transportation of the tool. A tapered shank (9) is secured to the shaft (8) by means of a pivot member (14). The pivot member may incorporate a hinge to allow rotation of the shank (9) merged to the shaft. Alternatively, the pivot member may be fixed so that the shank (9) is maintained at a constant orientation convenient to allow actuation of the tool. The head of the tool (33) is key-shaped having two diametrically opposed protuberances (34) to facilitate insertion into the socket when in the correct orientation.

FIG. 10 illustrates use of the tool for removal of the security plug. A plug engaging member (35) is inserted on the distal end of shaft (8) allowing the plug to be inserted or removed without need for a user to bend down.

FIG. 11 is a detailed view illustrating the bolt (5) and integral tooth rack (12). As shown in FIG. 11 the tooth rack (12) is laterally offset from the axis of the bolt. The rack (12) is also offset vertically from the axis of the bolt to accommodate the pinion shown in greater detail in FIG. 13.

FIG. 12 shows the construction of the upper housing portion. The upper housing portion forms a cover over the socket provided by the lower housing portion and pinion shown in FIGS. 13 and 14. The upper covering portion of the housing (15) has an axial bore and two diametrically opposed radially extending recesses (16) which form a socket for reception of the T-shaped head of the tool. Rotation of the tool in the socket allows the protuberances of the tool to be received in the two rebates (19), locking the tool into the housing to facilitate removal of the cover.

FIG. 13 illustrates the pinion, the socket (18) and diametrically opposed recesses (17) have a cup-shaped configuration to snugly receive the head of the tool. A sleeve extending downwardly from the cup-shaped portion includes a cylindrical toothed Gear (36) adapted to drive the rack (20) to actuate the bolt (5).

The lower housing portion is shown in FIG. 14. A sleeve (11) adapted to receive the bolt (5) and seal (7) has a guideway (37) to receive the rack (12). A cup (38) receives the pinion (13) allowing rotation of the pinion in use.

FIG. 15 shows the security plug.

FIG. 16 is a detailed view of the head of the tool, the shank (9) being fixed in relation to the shaft.

FIG. 17 is a cross-sectional view showing the attachment of the tool to the security plug (23) for insertion or removal of the plug. The tool has wedge-shaped teeth (35) adapted to be received into and engage the wedge-shaped recesses (24) on the upper face of the security plug. The angle of the wedge-shaped teeth (35) is more acute than the corresponding angle of the recess (24). In this way, insertion of the tool into the recesses ejects dirt and debris which may have accumulated, avoiding the need for separate cleaning of the security plug prior to removal.

1. An access cover comprising a generally non-metallic body, the body being adapted to be received in a frame to provide a closure for an access chamber; at least one locking mechanism adapted to releasably secure the body to the frame; the locking mechanism being adapted to be actuated by a tool; the locking mechanism comprising: a bolt moveable between an extended position wherein the bolt may be engaged within a recess of the frame; a retracted position wherein the bolt may be withdrawn from a recess to permit removal of the cover from the frame; and a socket adapted to receive the tool to actuate the locking mechanism and to permit lifting of the cover using the tool.

2. An access cover as claimed in claim 1 wherein the mechanism is embedded in the body.

3. An access cover as claimed in claim 1 wherein the locking mechanism is adapted so that the tool may be engaged within the locking mechanism when the bolt is retracted.

4. An access cover assembly comprising a cover as claimed in claim 1 together with a tool.

5. An access cover assembly as claimed in claim 4 wherein the tool includes a head adapted to be inserted into the socket, the head being rotated to actuate the locking mechanism in use.

6. An access cover assembly as claimed in claim 1 wherein the head includes at least one radially extending protuberance, the socket having a complementary shaped mouth to permit insertion and engagement with the tool in the first orientation but preventing removal of the tool after rotation of the tool within the socket.

7. An access cover assembly as claimed in claim 4 wherein the head of the tool comprises a cylindrical body with two diametrically opposed radially extending protuberances, the socket having a cover plate with an aperture defining a mouth to receive the head with the protuberances aligned in the bolt extended position.

8. An access cover assembly as claimed in claim 7 wherein the downwardly facing inner surface of the cover plate has one or more rebates or abutments dimensioned to receive the protuberance or protuberances when the tool is rotated to the bolt retracted position.

9. An access cover or access cover assembly as claimed in claim 1 wherein the bolts include a toothed rack adapted to engage a pinion on the socket.

10. An access cover or access cover assembly as claimed in claim 9 wherein the rack is laterally offset from the axis of the bolt.

11. An access cover or access cover assembly as claimed in claim 10 wherein the axis of rotation of the socket and tool are aligned with the longitudinal access of the bolt.

12. An access cover or access cover assembly as claimed in claim 1 but including a security plus to seal the socket.

13. An access cover or access cover assembly as claimed in claim 12 wherein a deadlocking member extends downwardly from the plug.

14. An access cover or access cover assembly as claimed claim 1 wherein a spring urges the pinion upwardly into contact with the housing.

15. A lifting tool for an access chamber comprising:
a shaft; a handle at a proximal end of the shaft; and a head at a distal end of the shaft; the head being adapted to operatively engage a socket in the cover in accordance with the first aspect of the invention.

16-17. (canceled)

18. An access cover as claimed in claim 2 wherein the locking mechanism is adapted so that the tool may be engaged within the locking mechanism when the bolt is retracted.

19. An access cover assembly as claimed in claim 5 wherein the head of the tool comprises a cylindrical body with two diametrically opposed radially extending protuberances, the socket having a cover plate with an aperture defining a mouth to receive the head with the protuberances aligned in the bolt extended position.

20. An access cover assembly as claimed in claim 6 wherein the head of the tool comprises a cylindrical body with two diametrically opposed radially extending protuberances, the socket having a cover plate with an aperture defining a mouth to receive the head with the protuberances aligned in the bolt extended position.
